(19) United States
(12) Patent Application Publication
(10) Pub. No.: US 2015/0134660 A1
(43) Pub. Date: May 14, 2015

(54) DATA CLUSTERING SYSTEM AND METHOD

(71) Applicant: General Electric Company, Schenectady, NY (US)

(72) Inventors: Weizhong Yan, Clifton Park, NY (US); Mark Richard Gilder, Clifton Park, NY (US); Umang Gopalbhai Brahmakshatriya, Niskayuna, NY (US)

(73) Assignee: General Electric Company, Schenectady, NY (US)

(21) Appl. No.: 14/080,096

(22) Filed: Nov. 14, 2013

(51) Int. Cl. G06F 17/30

(52) U.S. Cl. CPC G06F 17/30598
USPC 707/737

(57) ABSTRACT

A system includes identification of a first dataset comprising n data samples, identification of b data samples of the n data samples of the first dataset, wherein b is less than n, creation of a first plurality of datasets, each of the first plurality of datasets comprising m data samples, where m is greater than b, and wherein each of the m data samples of each of the first plurality of datasets is selected from the b data samples, identification of c data samples of the n data samples of the first dataset, wherein c is less than n, and wherein the c data samples are not identical to the b data samples, creation of a second plurality of datasets, each of the second plurality of datasets comprising p data samples, where p is greater than c, and wherein each of the p data samples of each of the second plurality of datasets is selected from the c data samples, identification, for each of the b data samples, of a cluster based on the first plurality of datasets, and identification, for each of the c data samples, of a cluster based on the second plurality of datasets.

### BACKGROUND

Modern computing systems generate massive amounts of data. For example, a business may be constantly generating data relating to production, logistics, sales, human resources, etc. This data may be stored as records within relational databases, multi-dimensional databases, data warehouses, and/or other data storage systems.

Due to the size and information density of this data, characterization, categorization and analysis thereof can be unwieldy, if not impossible or cost-prohibitive. Various processing techniques have attempted to address this issue. Some techniques utilize “data clustering”, which generally involves organizing data into groups, or clusters, in which the members of each cluster are somehow related.

FIG. 1 illustrates one example of a clustering operation. Dataset 10 includes a large number of records (e.g., n), with each of these records including several attributes (i.e., fields). Each of datasets 12, 14, 16 and 18 includes a small sample of dataset 10. For example, dataset 10 may include ten thousand records, and each of datasets 12, 14, 16 and 18 may include one hundred records randomly chosen from the ten thousand records of dataset 10.

A clustering algorithm (e.g., a Power Iteration Clustering algorithm) is applied to each of datasets 12, 14, 16 and 18. The clustering algorithm generates a value corresponding to each record of its subject dataset. For example, clustering algorithm 20 is applied to dataset 12 and generates a value associated with each record of dataset 12. These generated values form the illustrated vector y₁. The value associated with a record of dataset 12 may be used to determine a cluster to which the record belongs, for example by locating the value within a plot of each value of vector y₁, or may specifically identify a cluster to which the record belongs. Vectors y₂, y₃, and yₘ are generated similarly. All vectors are then fused to generate information which indicates the cluster to which each record of dataset 10 belongs.

The operation of FIG. 1 presents several drawbacks. Increasing the size of datasets 12, 14, 16 and 18 may improve the accuracy of the resulting clustering information, but also requires additional volatile memory (e.g., Random Access Memory) for application of the clustering algorithm. Moreover, generation of each of datasets 12, 14, 16 and 18 requires shared access to dataset 10, which may cause a performance bottleneck. Systems are desired to address these and/or other deficiencies.

### BRIEF DESCRIPTION OF THE DRAWINGS

FIG. 1 illustrates a clustering operation.

FIG. 2 is a block diagram of a computing system according to some embodiments.

FIG. 3 is a tabular representation of database records according to some embodiments.

FIG. 4 is a flow diagram of a clustering operation according to some embodiments.

FIG. 5 illustrates a clustering operation according to some embodiments.

FIG. 6 illustrates a clustering operation according to some embodiments.

FIG. 7 illustrates a clustering operation according to some embodiments.

FIG. 8 is a block diagram of a computing system according to some embodiments.

### DESCRIPTION

The following description is provided to enable any person in the art to make and use the described embodiments. Various modifications, however, will remain readily apparent to those in the art.

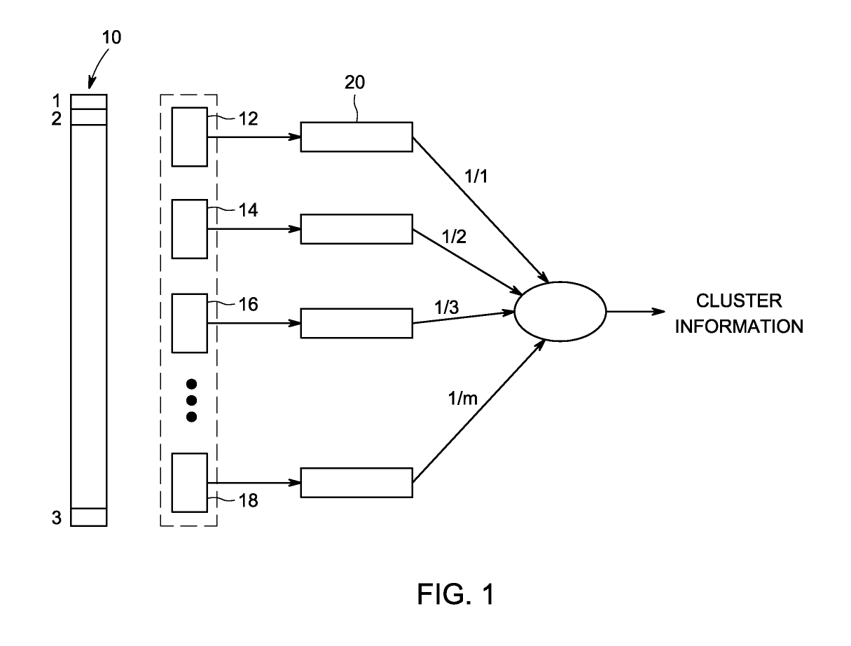

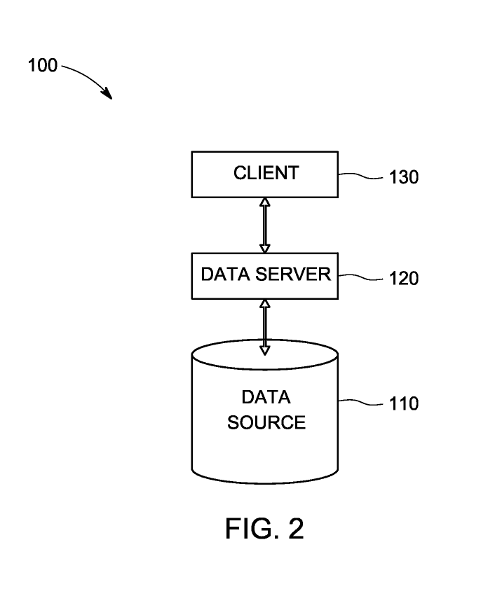

FIG. 2 is a block diagram of system 100 according to some embodiments. FIG. 1 represents a logical architecture for describing systems according to some embodiments, and actual implementations may include more or different components arranged in other manners.

Data source 110 may comprise any query-responsive data source or sources that are or become known, including but not limited to a structured-query language (SQL) relational database management system. Data source 110 may comprise a relational database, a multi-dimensional database, an eXtendable Markup Language (XML) document, or any other data storage system storing structured and/or unstructured data. The data of data source 110 may be distributed among several relational databases, multi-dimensional databases, and/or other data sources. Embodiments are not limited to any number or types of data sources. For example, data source 110 may comprise one or more OnLine Analytical Processing (OLAP) databases (i.e., cubes), spreadsheets, text documents, presentations, etc.

Data source 110 may comprise persistent storage (e.g., one or more fixed disks) for storing the full database and volatile (e.g., non-disk-based) storage (e.g., Random Access Memory) for cache memory for storing recently-used data.

Data server 120 may provide an interface to data source 110. For example, data server 120 may comprise a Relational Database Management System (RDBMS) which provides a query language server for allowing external access to data of data source 110. Data server 120 may also perform administrative and management functions, including but not limited to snapshot and backup management, indexing, optimization, garbage collection, and/or any other database functions that are or become known.

Data server 120 may be implemented by processor-executable program code executed by one or more processors, which may or may not be located in a same chassis as the fixed disks and RAM of data source 110.

Client 130 may comprise one or more devices executing program code of a software application for presenting user interfaces to allow interaction with data server 120. Presentation of a user interface may comprise any degree or type of rendering, depending on the coding of the user interface. For example, client 130 may execute a Web Browser to receive a Web page (e.g., in HTML format) from data server 120, and may render and present the Web page according to known protocols. Client 130 may also or alternatively present user interfaces by executing a standalone executable file (e.g., an .exe file) or code (e.g., a JAVA applet) within a virtual machine.

Any number of intermediate devices, systems and/or software applications may reside between client 130 and data server 120, and one or more of these devices, systems and/or applications may execute one or more of the functions attributed to data server 120 herein. For example, an application server may provide an interface through which client 130 may access data of data source 110. In response to requests received from client 130 through the interface, the application server may request data from data server 120, receive data therefrom, execute any required processing and/or analysis of the data, and return results to client 130.

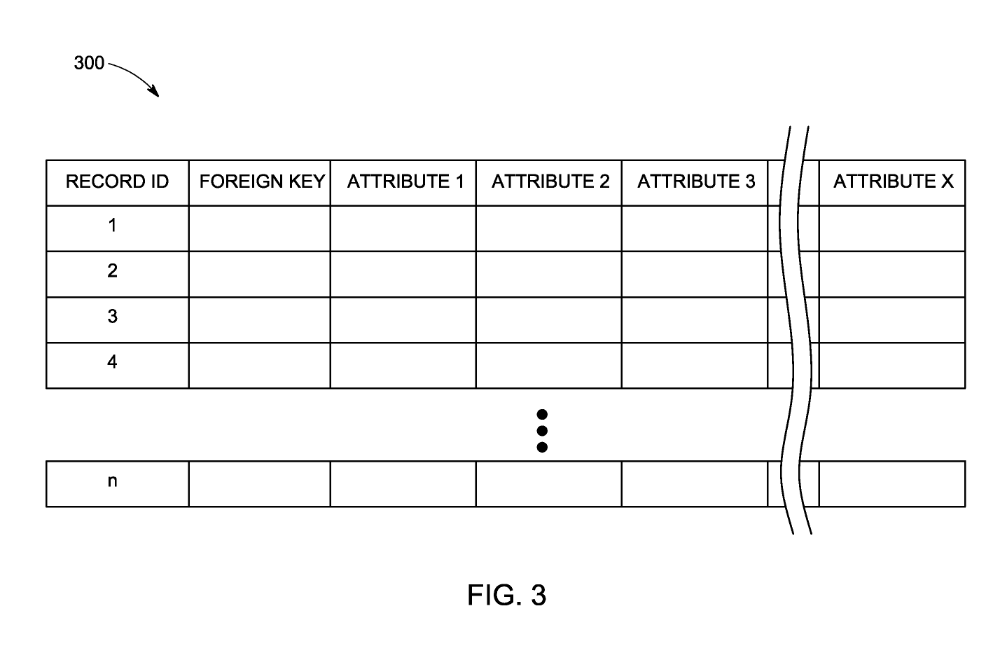

FIG. 3 is a tabular representation of a portion of dataset 300 according to some embodiments. Dataset 300 includes several (i.e., n) records, and each record includes several (i.e., x) attributes. According to one non-exhaustive example, each record of dataset 300 may correspond to a patient, with each attribute specifying identifying or medically-related information associated with the patient. The records of dataset 300 may be received from one or disparate sources, and the data of a single record may be received from one or more sources. Dataset 300 may be stored in data source 110 according to any protocol that is or becomes known. Embodiments are not limited to datasets which are formatted as illustrated in FIG. 3.

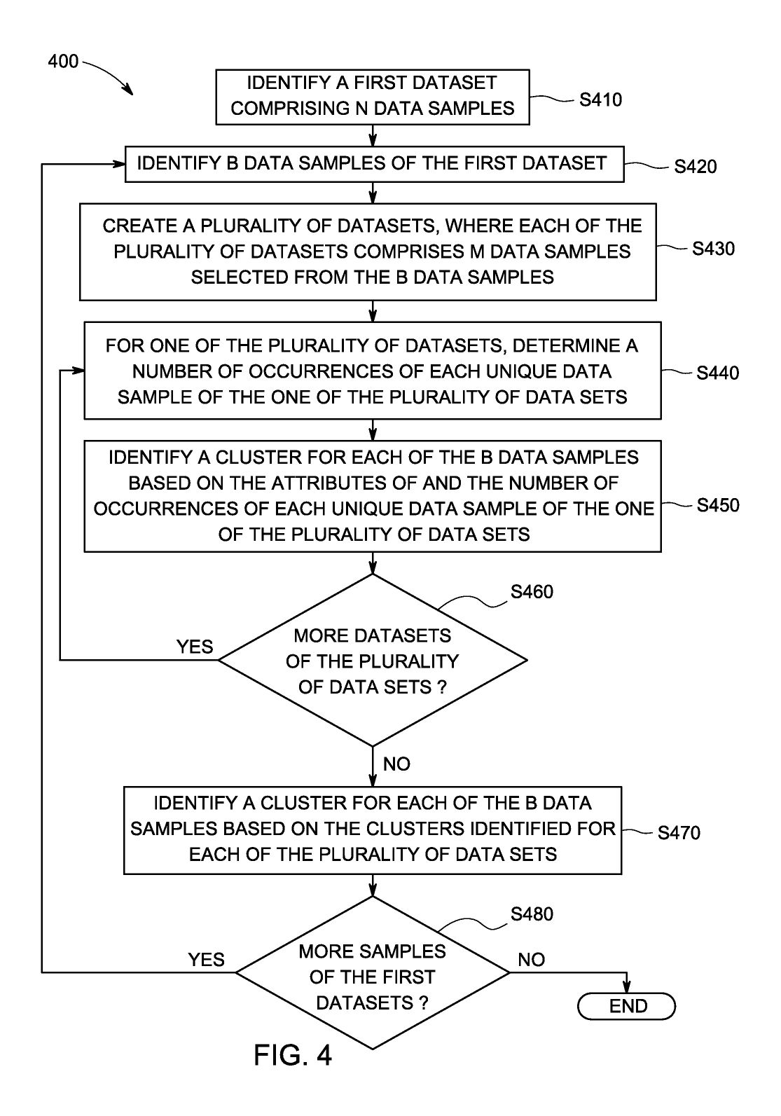

FIG. 4 comprises a flow diagram of process 400 according to some embodiments. In some embodiments, various hardware elements (e.g., a processor) of data server 120 execute program code to perform process 400. Process 400 and all other processes mentioned herein may be embodied in processor-executable program code read from one or more non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S410, a first dataset comprising n data samples is identified. n may be any large integer, but embodiments may also provide advantages in the case of smaller datasets. The first dataset may comprise any type of data, and each data sample may comprise any number of attributes. Generally, the first dataset may comprise any set of data samples which are to be grouped into clusters according to some embodiments.

In some embodiments, a user operates client 130 to select a dataset at S410. With respect to one of the above-mentioned examples, S410 may comprise identification of a set of patient records which are to be grouped into clusters in response to an instruction received from a user via client 130.

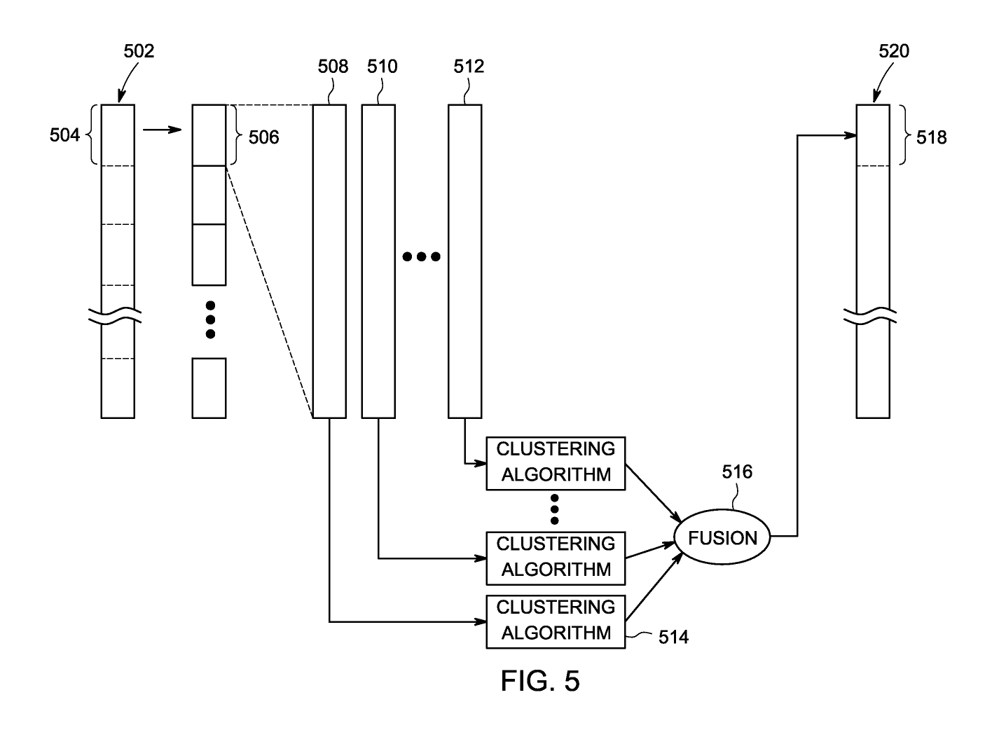

Next, at S420, a subset of the first dataset is identified. The subset includes b data samples, where b is less than n. FIG. 5 illustrates the selection of b data samples of the first dataset at S420 according to some embodiments.

FIG. 5 shows first dataset 502 including n data samples. First dataset 502 includes portion 504 which includes 1^{st} through b-th data samples of first dataset 502. According to some embodiments, the data samples of first portion 504 are identified at S420. Data samples 506 of FIG. 5 represent the identified b data samples.

A plurality of datasets are then created at S430. Each of the plurality of datasets includes m data samples selected from the b data samples identified at S420. m is equal to n according to some embodiments. Referring again to FIG. 5, datasets 508 through 512 represent datasets created at S430 from data samples 506 according to some embodiments.

More specifically, dataset 508 is created at S430 by performing m random selections (with replacement) from data samples 506. Accordingly, dataset 508 includes only data samples which also belong to data samples 506. Datasets 510 and 512 are created similarly, but will differ from one another due to the random selection of data samples from data samples 506. Datasets 510 and 512 will therefore also only include data samples from data samples 506. As illustrated in FIG. 5, more than three datasets may be created at S430 according to some embodiments.

A number of occurrences of each unique data sample of one of the plurality of datasets is determined at S440. In this regard, dataset 508 includes more data samples than data samples 506 (i.e., m>b). However, since dataset 508 includes only those data samples of data samples 506, at least one of data samples 506 is repeated within dataset 508. S440 therefore seeks to determine, for each unique data sample of dataset 508, how many times that data sample is repeated within dataset 508.

Next, at S450, a cluster is identified for each of the b unique data samples identified at S420. The clusters are identified based on the attributes of each b unique data sample and on the number of occurrences of each unique data sample determined at S440.

In one example of S450, clustering algorithm 514 of FIG. 5 receives each unique data sample of dataset 508 (i.e., b or fewer data samples), and, for each data sample, a number indicating how many times the data sample appears in dataset 508. Clustering algorithm 514 then operates to identify a cluster for each data sample. Generally, data samples with similar values most likely belong to the same cluster, while data samples with significantly different values most likely belong to different clusters.

Identification of clusters at S450 may include generating an output vector including a value for each unique data sample of dataset 508. In this regard, a plot of all such values would illustrate distinct groups of values, thereby visually indicating the cluster to which each data sample belongs. Identification of a cluster at S450 may further include generating a cluster identifier (e.g., “3”) for each unique data sample based on the output vector.

Advantageously, clustering algorithm 514 operates on b (or fewer) data samples and an integer (i.e., the number of occurrences) associated with each data sample. Accordingly, the memory demands of the clustering operation are significantly less than an algorithm which requires all m data samples of dataset 508.

Clustering algorithm 514 may comprise a Power Iteration Clustering algorithm which operates on inputs including the attributes of each data sample and a number of occurrences associated with each data sample, but embodiments are not limited thereto. According to some embodiments, the following clustering algorithm is employed at S450:

Given b data samples, {dᵢ, i=1, 2, . . . , b}, and the count of occurrences {COᵢ, 1=1, 2, . . . , b}, corresponding to each of the b data samples:

Normalize counts, Cᵢ=COᵢ/ΣᵢCOᵢ

Calculate the affinity matrix A, Aᵢⱼ=S(dᵢ,dⱼ), where S is a similarity function (e.g.,

$$S ( {d}_{i} , {d}_{j} ) = exp ( - \frac{{‖ {d}_{i} - {d}_{j} ‖}_{2}^{2}}{2 {σ}^{2}} ) )$$

Calculate the degree matrix D, a diagonal matrix, associated with A, Dᵢᵢ=ΣⱼCᵢAᵢⱼ

Obtain the normalized affinity matrix W, W=D⁻¹ A

Generate the initial vector, vᵢ⁰=Rᵢ/(ΣᵢRᵢ), where Rᵢ=ΣⱼWᵢⱼ

Repeat the following calculations, v^{t}=γWv^{t-1}, δ^{t}=|v^{t}−v^{t-1}|, until |δ^{t}−δ^{t-1}|≈0

Output the final vector v^{t}

(optional) Cluster the final vector and output the cluster labels

Flow proceeds to S460 after the identification of clusters at S450. At S460, it is determined whether any of the datasets created at S430 remain to be processed. If so, flow returns to S440.

According to the present example, flow returns to S440 to determine a number of occurrences of each unique data sample of dataset 510. This operation proceeds as described above with respect to dataset 508. However, because dataset 510 differs from dataset 508, the numbers of occurrences associated with each unique data sample will likely differ from the numbers determined with respect to dataset 508.

Clusters are identified at S450 as described above, based on the number of occurrences of each unique data sample of dataset 510. Flow continues to cycle between S460 and S440 until clusters have been identified for each dataset created at S430. As described above, embodiments may create any number of datasets at S430.

Once each of the plurality of datasets has been processed, a cluster is identified for each of the b data samples 506 at S470. Identification of clusters at S470 is based on the clusters identified for each of datasets 508, 510 and 512 at S450.

FIG. 5 illustrates fusion of the information output from each clustering algorithm. Fusion may be performed on the output vector of each algorithm, or on individual cluster results determined from each individual output vector. The fusion output is therefore either an output vector including a value for each unique data sample of data samples 506 or a set of cluster identifiers, where each cluster identifier corresponds to a unique data sample of data samples 506.

For example, if the outputs of the clustering algorithms are values, fusion may be based on the arithmetic mean of all individual outputs. In another example, if the outputs of the clustering algorithms are cluster labels, fusion may be based on majority voting.

The fusion output is stored in memory portion 518 of output structure 520. According to some embodiments, each entry of memory portion 518 includes cluster information (i.e., a vector value or a cluster identifier) for a corresponding data sample of first portion 504. For example, cluster information for the first data sample of first portion 504 is stored in the first memory position of portion 518.

At S480, it is determined whether first dataset 502 includes additional data samples to be processed. If so, flow returns to S420 to identify a next b data samples of first dataset 502.

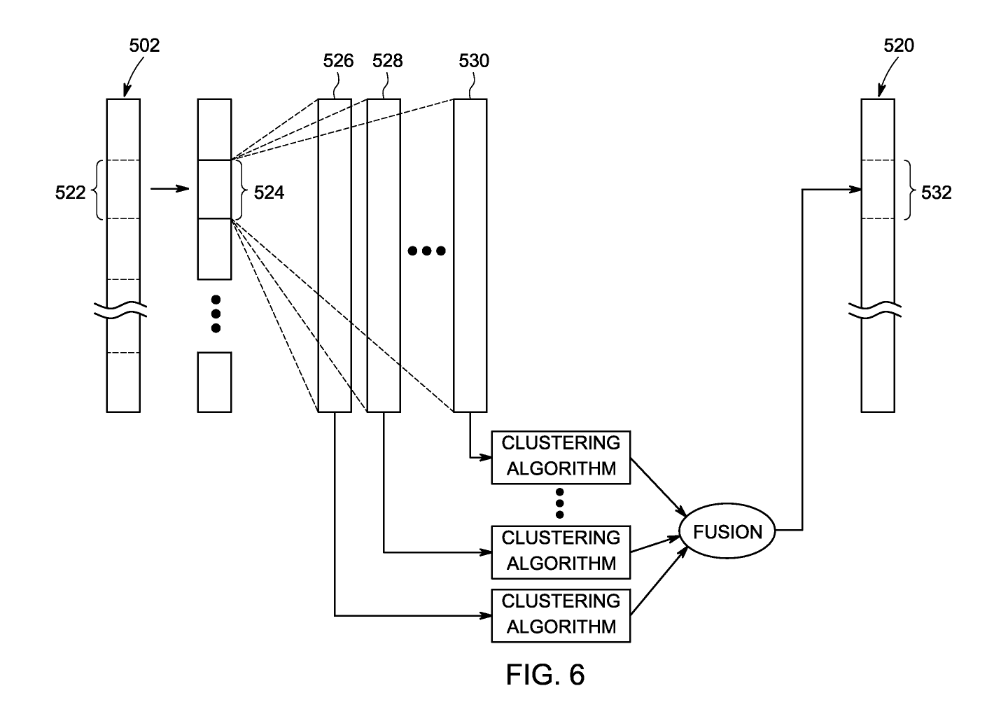

Flow therefore proceeds as described above with respect to the next b data samples of first dataset 502. Specifically, and as illustrated in FIG. 6, the data samples of second portion 522 are identified as b data samples 524 at S420. Datasets 526, 528 and 530 are then created at S430, each including m data samples selected from b data samples 524.

S440, S450 and S460 are then performed for each dataset 526, 528 and 530 in order to determine a number of occurrences of each unique data sample of each of the plurality of datasets, and to identify clusters for each unique data sample of each dataset based on the determined number of occurrences.

A cluster is identified for each of the b data samples 524 at S470, based on the clusters identified for each unique data sample of each dataset 526, 528 and 530. The resulting cluster information is stored in memory portion 532 of output structure 520. According to some embodiments, each entry of memory portion 532 includes cluster information (i.e., a vector value or a cluster identifier) for a corresponding data sample of second portion 522.

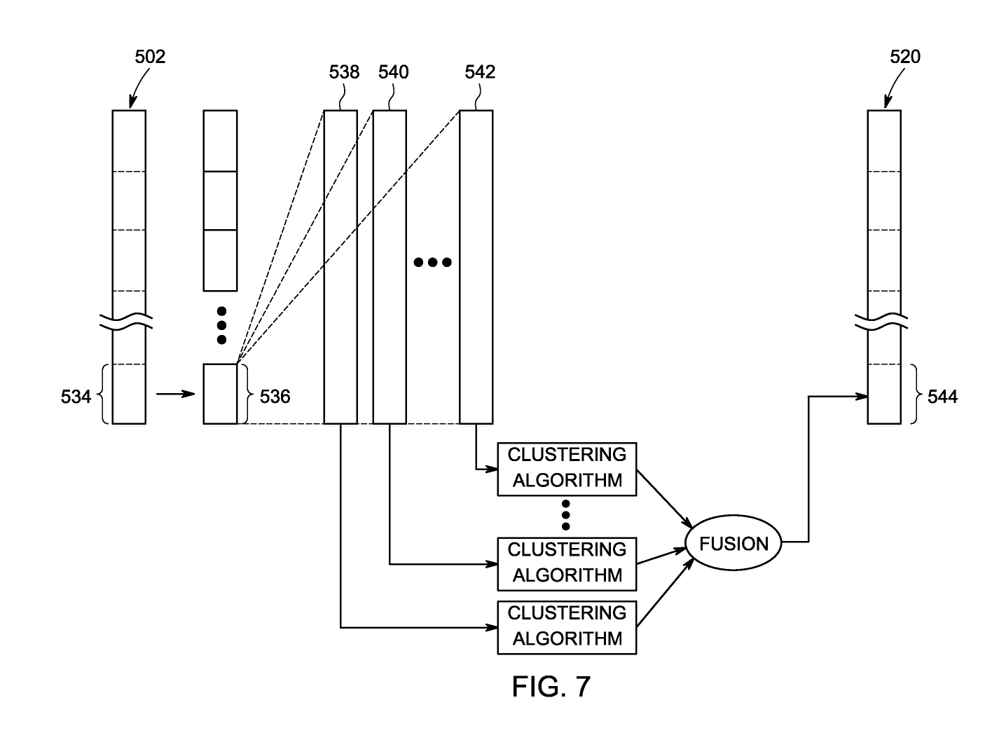

S420 through S480 are repeated until all data samples of first dataset 502 have been processed. FIG. 7 illustrates processing of last data portion 534 of first dataset 502. As shown, the data samples of last portion 534 are identified as b data samples 536 at S420, datasets 538, 540 and 542 are created at S430, and clusters are identified for each unique data sample of each dataset based on the number of occurrences of each unique data sample of each dataset.

A cluster is identified for each of the b data samples 536 at S470, based on the clusters identified for each unique data sample of each dataset 538, 540 and 542. The resulting cluster information is stored in memory portion 544 of output structure 520, such that each entry of memory portion 544 includes cluster information (i.e., a vector value or a cluster identifier) for a corresponding data sample of last portion 534.

Output structure 520 therefore includes cluster information for each data sample of dataset 502. Since all data samples of dataset 502 have been processed, process 400 thereafter terminates.

In addition to the efficient use of memory described above, some embodiments provide advantageous opportunities for parallel processing. For example, S420 through S470 can be executed in parallel for each of set of b data samples of dataset 502. In this regard, dataset 502 may be split into n/b portions, with two or more portions then being processed independently and in parallel as described with respect to S420 through S470. Moreover, within each of these independent and parallel processings, S440 through S460 may further be executed in parallel, for each of the datasets created at S430.

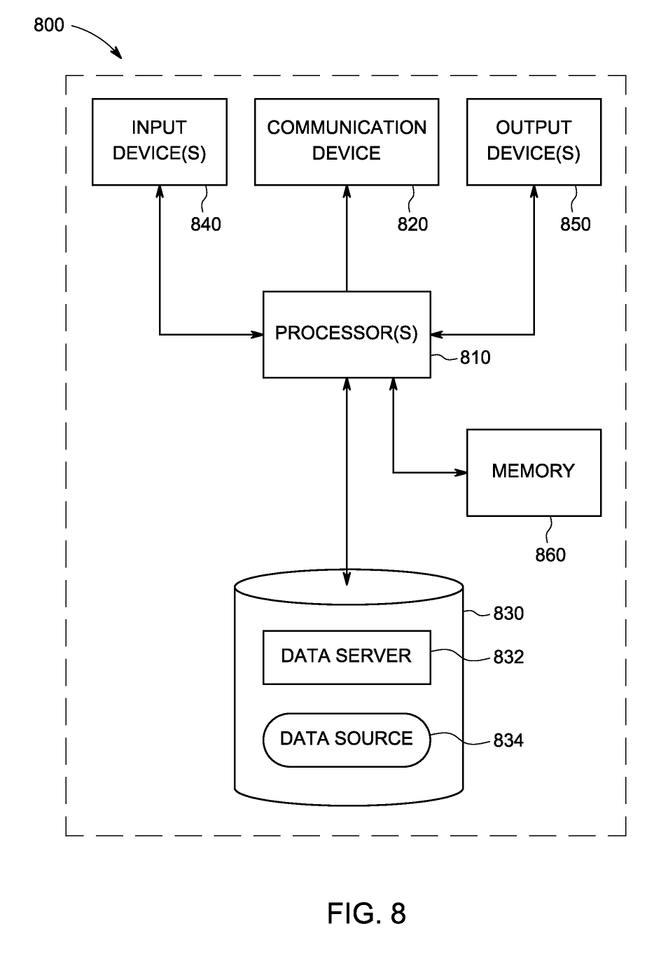

FIG. 8 is a block diagram of system 800 according to some embodiments. System 800 may comprise a general-purpose computing system and may execute program code to perform any of the processes described herein. System 800 may comprise an implementation of data source 110 and data server 120 according to some embodiments. System 800 may include other unshown elements according to some embodiments.

System 800 includes one or more processors 810 operatively coupled to communication device 820, data storage device 830, one or more input devices 840, one or more output devices 850 and memory 860. Communication device 820 may facilitate communication with external devices, such as a reporting client, or a data storage device. Input device(s) 840 may comprise, for example, a keyboard, a keypad, a mouse or other pointing device, a microphone, knob or a switch, an infra-red (IR) port, a docking station, and/or a touch screen. Input device(s) 840 may be used, for example, to enter information into apparatus 800. Output device(s) 850 may comprise, for example, a display (e.g., a display screen) a speaker, and/or a printer.

Data storage device 830 may comprise any appropriate persistent storage device, including combinations of magnetic storage devices (e.g., magnetic tape, hard disk drives and flash memory), optical storage devices, Read Only Memory (ROM) devices, etc., while memory 860 may comprise Random Access Memory (RAM).

Data server 832 may comprise program code executed by processor(s) 810 to cause computing system 800 to perform any one or more of the processes described herein. Embodiments are not limited to execution of these processes by a single apparatus. In addition to data server 832 and data source 834, data storage device 830 may store data and other program code for providing additional functionality and/or which are necessary for operation of system 800, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of an embodiment may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those skilled in the art will recognize other embodiments may be practiced with modifications and alterations to that described above.

What is claimed is:

1. A non-transitory computer-readable medium storing program code, the program code executable by a processor of a computing system to cause the computing system to:
identify a first dataset comprising n data samples;
identify b data samples of the n data samples of the first dataset, wherein b is less than n;
create a first plurality of datasets, each of the first plurality of datasets comprising m data samples, where m is greater than b, and wherein each of the m data samples of each of the first plurality of datasets is selected from the b data samples;
identify c data samples of the n data samples of the first dataset, wherein c is less than n, and wherein the c data samples are not identical to the b data samples;
create a second plurality of datasets, each of the second plurality of datasets comprising p data samples, where p is greater than c, and wherein each of the p data samples of each of the second plurality of datasets is selected from the c data samples;
for each of the b data samples, identify a cluster based on the first plurality of datasets; and
for each of the c data samples, identify a cluster based on the second plurality of datasets.

2. A non-transitory computer-readable medium storing program code according to claim 1, wherein identification of a cluster for each of the b data samples based on the first plurality of datasets comprises:
identification of a cluster of each of the m data samples of a first one of the first plurality of datasets; and
identification of a cluster of each of the m data samples of a second one of the first plurality of datasets.

3. A non-transitory computer-readable medium storing program code according to claim 2, wherein identification of a cluster of each of the m data samples of the first one of the first plurality of datasets comprises:
for each unique data sample of the first one of the first plurality of datasets, determination of a first number of occurrences of the unique data sample in the first one of the first plurality of datasets; and
identification of a cluster of each of the m data samples of the first one of the first plurality of datasets based on the unique data samples of the first one of the first plurality of datasets and the first numbers of occurrences, and
wherein identification of a cluster of each of the m data samples of the second one of the first plurality of datasets comprises:
for each unique data sample of the second one of the first plurality of datasets, determination of a second number of occurrences of the unique data sample in the second one of the first plurality of datasets; and
identification of a cluster of each of the m data samples of the second one of the first plurality of datasets based on the unique data samples of the second one of the first plurality of datasets and the second numbers of occurrences.

4. A non-transitory computer-readable medium storing program code according to claim 1, wherein identification of a cluster for each of the b data samples comprises:
for each unique data sample of the first one of the first plurality of datasets, determination of a first number of occurrences of the unique data sample in the first one of the first plurality of datasets;
for each unique data sample of the second one of the first plurality of datasets, determination of a second number of occurrences of the unique data sample in the second one of the first plurality of datasets; and
identification of a cluster for each of the b data samples based on the unique data samples of the first one of the first plurality of datasets, the first numbers of occurrences, the unique data samples of the second one of the first plurality of datasets, and the second numbers of occurrences.

5. A non-transitory computer-readable medium storing program code according to claim 1, wherein each of the m data samples of each of the first plurality of datasets is randomly selected from the b data samples, and
wherein each of the m data samples of each of the second plurality of datasets is randomly selected from the c data samples.

6. A non-transitory computer-readable medium storing program code according to claim 1, wherein b is equal to c and wherein m is equal to p.

7. A computing system comprising:
a memory storing processor-executable program code; and
a processor to execute the processor-executable program code in order to cause the computing system to:
identify a first dataset comprising n data samples;
identify b data samples of the n data samples of the first dataset, wherein b is less than n;
create a first plurality of datasets, each of the first plurality of datasets comprising m data samples, where m is greater than b, and wherein each of the m data samples of each of the first plurality of datasets is selected from the b data samples;
identify c data samples of the n data samples of the first dataset, wherein c is less than n, and wherein the c data samples are not identical to the b data samples;
create a second plurality of datasets, each of the second plurality of datasets comprising p data samples, where p is greater than c, and wherein each of the p data samples of each of the second plurality of datasets is selected from the c data samples;
for each of the b data samples, identify a cluster based on the first plurality of datasets; and
for each of the c data samples, identify a cluster based on the second plurality of datasets.

8. A computing system according to claim 7, wherein identification of a cluster for each of the b data samples based on the first plurality of datasets comprises:
identification of a cluster of each of the m data samples of a first one of the first plurality of datasets; and
identification of a cluster of each of the m data samples of a second one of the first plurality of datasets.

9. A computing system according to claim 8, wherein identification of a cluster of each of the m data samples of the first one of the first plurality of datasets comprises:
for each unique data sample of the first one of the first plurality of datasets, determination of a first number of occurrences of the unique data sample in the first one of the first plurality of datasets; and
identification of a cluster of each of the m data samples of the first one of the first plurality of datasets based on the unique data samples of the first one of the first plurality of datasets and the first numbers of occurrences, and
wherein identification of a cluster of each of the m data samples of the second one of the first plurality of datasets comprises:
for each unique data sample of the second one of the first plurality of datasets, determination of a second number of occurrences of the unique data sample in the second one of the first plurality of datasets; and
identification of a cluster of each of the m data samples of the second one of the first plurality of datasets based on the unique data samples of the second one of the first plurality of datasets and the second numbers of occurrences.

10. A computing system according to claim 7, wherein identification of a cluster for each of the b data samples comprises:
for each unique data sample of the first one of the first plurality of datasets, determination of a first number of occurrences of the unique data sample in the first one of the first plurality of datasets;
for each unique data sample of the second one of the first plurality of datasets, determination of a second number of occurrences of the unique data sample in the second one of the first plurality of datasets; and
identification of a cluster for each of the b data samples based on the unique data samples of the first one of the first plurality of datasets, the first numbers of occurrences, the unique data samples of the second one of the first plurality of datasets, and the second numbers of occurrences.

11. A computing system according to claim 7, wherein each of the m data samples of each of the first plurality of datasets is randomly selected from the b data samples, and
wherein each of the m data samples of each of the second plurality of datasets is randomly selected from the c data samples.

12. A computing system according to claim 7, wherein b is equal to c and wherein m is equal to p.

13. A computer-implemented method, comprising:
identifying a first dataset comprising n data samples;
identifying b data samples of the n data samples of the first dataset, wherein b is less than n;
creating a first plurality of datasets, each of the first plurality of datasets comprising m data samples, where m is greater than b, and wherein each of the m data samples of each of the first plurality of datasets is selected from the b data samples;
identifying c data samples of the n data samples of the first dataset, wherein c is less than n, and wherein the c data samples are not identical to the b data samples;
creating a second plurality of datasets, each of the second plurality of datasets comprising p data samples, where p is greater than c, and wherein each of the p data samples of each of the second plurality of datasets is selected from the c data samples;
for each of the b data samples, identifying a cluster based on the first plurality of datasets; and
for each of the c data samples, identifying a cluster based on the second plurality of datasets.

14. A computer-implemented method according to claim 13, wherein identifying a cluster for each of the b data samples based on the first plurality of datasets comprises:
identifying a cluster of each of the m data samples of a first one of the first plurality of datasets; and
identifying a cluster of each of the m data samples of a second one of the first plurality of datasets.

15. A computer-implemented method according to claim 14, wherein identifying a cluster of each of the m data samples of the first one of the first plurality of datasets comprises:
for each unique data sample of the first one of the first plurality of datasets, determining a first number of occurrences of the unique data sample in the first one of the first plurality of datasets; and
identifying a cluster of each of the m data samples of the first one of the first plurality of datasets based on the unique data samples of the first one of the first plurality of datasets and the first numbers of occurrences, and
wherein identifying a cluster of each of the m data samples of the second one of the first plurality of datasets comprises:
for each unique data sample of the second one of the first plurality of datasets, determining a second number of occurrences of the unique data sample in the second one of the first plurality of datasets; and
identifying a cluster of each of the m data samples of the second one of the first plurality of datasets based on the unique data samples of the second one of the first plurality of datasets and the second numbers of occurrences.

16. A computer-implemented method according to claim 13, wherein identifying a cluster for each of the b data samples comprises:
for each unique data sample of the first one of the first plurality of datasets, determining a first number of occurrences of the unique data sample in the first one of the first plurality of datasets;
for each unique data sample of the second one of the first plurality of datasets, determining a second number of occurrences of the unique data sample in the second one of the first plurality of datasets; and
identifying a cluster for each of the b data samples based on the unique data samples of the first one of the first plurality of datasets, the first numbers of occurrences, the unique data samples of the second one of the first plurality of datasets, and the second numbers of occurrences.

17. A computer-implemented method according to claim 13, wherein each of the m data samples of each of the first plurality of datasets is randomly selected from the b data samples, and
wherein each of the m data samples of each of the second plurality of datasets is randomly selected from the c data samples.

18. A computer-implemented method according to claim 13, wherein b is equal to c and wherein m is equal to p.
